(19) United States
(12) Patent Application Publication
(10) Pub. No.: US 2005/0064141 A1
(43) Pub. Date: Mar. 24, 2005

(54) Structural component and method and a mold tool for its production

(76) Inventors: Joachim Flaig, Kongen (DE); Axel Lachenmaier, Rudensberg (DE)

Correspondence Address: Mr. Robin W. Asher;Clark Hill, P.L.C., Suite 3500, 500 Woodward Avenue, Detroit, MI, 48226-3435, US

(21) Appl. No.: 10/942,369

(22) Filed: Sep. 16, 2004

(30) Foreign Application Priority Data
Sep. 23, 2003 (DE) 10346219.8

(51) Int. Cl. B32B 1/00

(52) U.S. Cl. 428/141; 264/255; 264/250

(57) ABSTRACT

A method is described for manufacturing a structural component (10) with a varnish exterior surface, with the steps of: providing of a varnish film (11), the exterior surface (18) of which is substantially smooth, thermoforming the varnish film and back molding the varnish film with a carrier material (12) in particular made of plastic, wherein during at least one of the two steps consisting of thermoforming and back molding, an exterior surface (18) of the varnish film is provided with a surface structure (21), which causes uneven reflection on the exterior surface.

### FIELD OF THE INVENTION

The invention relates to a structural component with a varnished exterior surface, which is provided with a surface structure and also a method and a mold tool for its production.

### BACKGROUND OF THE INVENTION

Structural components are of importance in the most diverse technical applications, when outside forces affect such components or if a complete assembly, which has to meet high rigidity and strength requirements, is formed by such components. In particular with regard to automotive construction, the use of structural components is known in the form of roof members, door linings, mudguards and the like. Generally, in the case of an automobile body, such structural components are produced from metal, which is then varnished, wherein the paint prevents undesirable corrosion of the metal and imparts a desired optical appearance on the body. Varnished structural components made of metal are generally not completely smooth on their exterior surface, but have a so-called “orange peel effect”. This effect is due to slight rippling on the exterior paint surface of the structural component, which the viewer perceives as slightly uneven light reflection and to the extent desired invokes the association of a solid metal part.

Over the past few decades, especially in automotive construction, lightweight production has been the prime consideration, as the result of which metal parts have been increasingly substituted by plastic parts. Such structural components made of plastic are generally manufactured in a two-step production process, according to which firstly a varnish film is preferably thermoformed, and afterwards the thermoformed varnish film is back molded with a suitable carrier material, for example by back foaming or back injection molding with a further plastic. The exterior surface of the structural component produced in this way, which is either varnished or onto which the varnish film is placed, however is substantially smooth. Regular light reflection arising as a result on this exterior surface however does not give the viewer the impression that this structural component is made of normal sheet metal. Although such plastic structural components can even be superior in their mechanical characteristics to sheet metal parts, disadvantageously this can lead to problems with the customer accepting the corresponding product, an automobile for example.

Conventional paint finishing of components, which also includes the paint finishing of plastic production parts, is subject to the disadvantage of so-called over-spray, the consequence being that some of the paint material leaving the spray gun nozzle does not adhere to the surface to be coated, but is lost for example in the form of spray mist, lean application or the like. To this extent conventional paint finishes are not particularly efficient.

Accordingly, the underlying object of the invention is to produce a structural component from plastic whereby the paint finish on an exterior surface does not invoke any distinction with a varnished metal part.

### SUMMARY OF THE INVENTION

Using the method in accordance with the invention a structural component with a varnished exterior surface can be produced, which due to the so-called “orange peel effect” creates the same optical appearance as a varnished metal structural component. In the case of the method in accordance with the invention firstly a varnish film is produced, the exterior surface of which is substantially smooth. This varnish film is then molded, in order to produce a contour, which substantially corresponds to the contour of the structural component previously made. After contouring the varnish film is back molded with a plastic carrier material, which guarantees the required mechanical characteristics of the structural component in respect to rigidity, strength and the like. A substantial feature of the method in accordance with the invention lies in the fact that during at least one of the two contouring and back molding steps an exterior surface of the varnish film is provided with a surface structure, which causes uneven reflection. An especially suitably contoured surface of the varnish film can be obtained in particular if the surface structure is ingrained in the exterior surface of the varnish film during both the contouring and back molding steps.

Back molding in accordance with the invention is to be understood in the sense of back filling, following which the side of the varnish film, which faces the side with the wanted surface structure, is provided with a reinforcing material in the form of a carrier material, in order to impart the necessary mechanical characteristics on the structural component in accordance with the invention.

The varnish film can be suitably contoured by thermoforming in particular an extruded film or a co-extruded film, or alternatively by original molding a Duromer plastic molding material preferably by means of the rotational centrifuging process. After rotational centrifuging the contoured varnish film can be finished as necessary, in order to obtain the shade required for the structural component.

In order to obtain the effect with the structural component as explained above of uneven reflection on the exterior surface of the varnish film, the method in accordance with the invention is preferably carried out with a mold tool, i.e. a back molding die and/or a thermoforming die whereby the mold tool has a surface facing the cavity of the die in which a surface structure is ingrained. If during back molding and/or thermoforming of the varnish film its exterior surface is pressed against the surface of the mold tool, the surface structure of the mold surface is replicated on the exterior surface of the varnish film. This applies equally to the production method by means of rotational centrifuging, in which the Duromer molding material mentioned above is used. As a result therefore the varnish film, which possesses a substantially smooth exterior surface before thermoforming and/or back molding, acquires an exterior surface with a surface structure, which causes uneven reflection.

The surface of the mold tool, which faces the cavity of the die, in the known way can undergo surface treatment, in order to obtain the wanted structure. For example, the surface can be etched, sandblasted and/or coated, in order to produce the surface structure.

The method in accordance with the invention can be arranged such that the surface structure is ingrained in its exterior surface either only during molding, in particular thermoforming, or however only during back molding of the varnish film. Accordingly, either only the die for contouring or however only the back molding die as explained comprises the surface structure, which is replicated during the respective processing step in the exterior surface of the varnish film.

The processing steps for carrying out contouring in particular by way of thermoforming and subsequent back molding by way of back foaming or back injection molding are sufficiently known by the person skilled in the art and are not described here further. As an alternative to back foaming and/or back injection molding, back molding of the varnish film can also consist of back embossing, in particular using a known glass mat thermoplastic (GMT) or sheet molding component (SMC) material.

Alternatively, it is also possible with a further refinement of the invention to impart a surface structure on the exterior surface of the varnish film during both the contouring and back molding steps. In this case therefore it concerns overlaying replications of the surface structure ingrained in the various mold tools (for example thermoforming die and back molding die) on the exterior surface of the varnish film, the replications of which build up finally to an overall structure on the exterior surface of the varnish film. If a corresponding surface structure is provided both in the die for contouring and in the back molding die for replication on the exterior surface of the varnish film, advantageously more complex and finer structures can be obtained on the exterior surface of the varnish film so that the optical appearance of the varnish film resembles more closely that of a varnished metal part.

In another advantageous refinement of the invention the varnish film is back foamed during the processing step of back molding, for which a polyurethane (PUR) system is particularly suitable. Generally, PUR systems for example compared to thermoplastic materials offer the advantage of a high grade material, which is demonstrated not least by better mechanical characteristics and higher quality of the structural component produced. In particular for making very large and at the same time very rigid components, for example roof modules, a glass-fiber reinforced PUR-foam is suitable for back foaming the varnish film. The fiber reinforcement can be suitably obtained by prefabricated glass matting, which is laid and positioned accordingly in the die cavity before foaming. Alternatively or in addition to this, the glass fiber reinforcement can also be obtained by means of a compound, which contains chopped fibers in the correspondingly required length. The compound is likewise inserted into the die cavity before foaming.

The internal die pressure, which arises in the die cavity during the foaming process, is only a few bar, and can for example reach a value of up to approximately 15 bar. Since such internal pressure is comparatively low, the surface of the varnish film is preferably structured in the previous processing step of contouring, in particular by way of thermoforming. Alternatively, in the case of a structural component which is back foamed in the last processing step, the mold tool used for molding has a corresponding surface structure on the surface facing the cavity of the die. The surface structure is therefore essentially imparted on the exterior surface of the varnish film during contouring, so that the comparatively low internal pressures do not disadvantageously affect the desired structure during the back foaming process.

A further effect of low internal die pressure during the foaming process described is that possible minute errors in the preferably thermoformed film can no longer be “ironed-out” during back foaming. To guarantee an excellent surface (the so-called “class A surface finish”) of the varnish film and/or the structural component—apart from the quality of the raw materials used—the surface quality and cleanliness of the thermoforming die is of crucial importance.

In accordance with another alternative refinement of the invention the back molding of the varnish film is carried out in particular by back injection molding with a thermoplastic sheet. In the case of back injection molding onto the varnish film the internal pressure in the cavity assumes a higher value in comparison to back foaming. Thus, the internal pressure can reach a value of approximately 700 bar for example. Accordingly, in this case the surface structure is preferably ingrained in the surface of the injection molding die, since due to the very high internal pressure in the cavity the varnish film is pressed against the die surface. This leads to reliable replication of the surface structure, which is ingrained in the die surface, on the exterior surface of the varnish film. In addition, as a result of the structure ingrained in the back molding die, the disadvantage that an otherwise smooth surface of the back injection molding die could in an undesirable way smooth out the structure of the exterior surface of the varnish film produced previously during the thermoforming process is avoided.

For back injection molding of the varnish film use is preferably made of fiber-reinforced thermoplastics, for example with reinforcement of short and/or long glass fibers. These materials have a characteristic profile, which is of major importance for body components, due to their high rigidity, their minimum thermal linear expansion and therefore the small changes in gap dimension and their virtually temperature-independent mechanical characteristics. Added to this the special requirements with regard to favorable crash resistance can be easily met by these materials. For example the rupture behavior of a structural component in accordance with the invention, in the case of which a varnish film from a non-reinforced thermoplastic is back injection molded with the material described above, is very advantageously influenced. Moreover, long fibers do not show through the varnish film, so that the required so-called class A-surface finish can be achieved in one processing step.

For introducing the fiber reinforcement during back injection molding the so-called long fiber injection (LFI) method is available for example, wherein the glass fibers are directly drawn by roving into the cavity. The LFI method is generally known and hence is not described in detail below. Other known methods, therefore not described here, for introducing the fiber reinforcement are for example the so-called LFT D process (“direct process for long-fiber-reinforced thermoplastics”), ILC (“in-line compounding”) or the like.

Apart from the glass fibers mentioned above other types of fiber are clearly suitable as reinforcing material for the structural component in accordance with the invention, for example carbon fibers, aramide fibers, or the like.

Both with back foaming and back injection molding it is ensured that the carrier material, which is back molded onto the varnish film is sufficiently bound with the varnish film. The outstanding adhesion to the film is assured due to fusion of at least the varnish film on the boundary surface of the two plastics, i.e. on the boundary surface of the varnish film to the carrier material.

During back foaming of the carrier material, preferably with a PUR system, the very high temperature rise during the reaction of polyhydroxy alcohol and isocyanate, the reaction of which can generate interior temperatures of up to 200° C., causes the varnish film to fuse on the side, which comes into contact with the PUR system. Adhesion is additionally achieved by a chemical reaction on the boundary surface.

If back molding of the varnish film is carried out by means of back injection molding, due to the high material temperature of approximately 210° C. for example and due to the very high internal pressures of up to 700 bar, fusion of the varnish film and the carrier material including of a thermoplastic sheet, can take place on the boundary surface described. In each case therefore sufficiently sound binding of the carrier material with the varnish film is guaranteed.

In another advantageous refinement of the invention the varnish film produced includes of an extruded film, which is varnished on its exterior surface before the thermoforming step. In this case, the varnish film for example can consist of polypropylene (PP), polycarbonate (PC) or a blend of polycarbonate and acryl butadiene styrene (PC-ABS) and for example have a film thickness of 0.5 to 1.4 mm. The properties of the varnish coating, which is applied on the extruded film before thermoforming and therefore produces a varnish film, are such that it is not damaged with subsequent deformation of the varnish film, for example assuming a flat component and with the effects of pressure and heat, which arise during the processing step of back molding. If the varnish film is carefully treated during the processing steps of thermoforming and back molding, normally no further rework of the structural component produced is necessary on its varnished exterior surface, since the varnish coating on the varnish film remains intact during the processing steps.

In another advantageous refinement of the invention, the varnish film produced concerns a co-extruded film, which includes a varnish coating and a base layer. In this case, the varnish coating, which is placed on the co-extruded film on the exterior surface of the varnish film, which during the processing steps of thermoforming and/or back molding comes into contact with the surfaces of the respective mold tools, on the surfaces of which the corresponding surface structure is ingrained. In the case of such coextruded film it is very reliably ensured that its varnish coating withstands the processing steps of thermoforming and back molding described without damage and as a result further rework of the structural component with respect to paint treatment is unnecessary.

The properties with regard to the varnished exterior surface or varnish coating of the extruded film and coextruded film, which can be produced in each case as a varnish film, are such that they easily meet the normal requirements for the finish of automobiles, which below are not described further.

For producing the varnish film, presently known methods are available. The film can be extruded conventionally and afterwards subjected to a so-called doctor knife process, whereby a surface of the extruded film is coated with varnish. Alternatively, the varnish film can also be formed from a co-extruded film, which includes a carrier film and a varnish film. In this case, the carrier film and the varnish film are extruded separately from one another and subsequently pressed together in the still hot and tacky state by means of a calender.

In accordance with another alternative, the varnish film can also be made from a Duromer plastic molding material, for example by means of the known rotational centrifuging process.

If the structural component in accordance with the invention, as explained above, is used for example in automotive construction, a preferred specific application of such a component relates to use as mudguards, engine bonnet, tailgates, a side part or even as a roof module. The mechanical characteristics of the structural component in accordance with the invention can be excellently influenced by an admixture of glass fibers, in the form of short or long glass fibers. Trials have shown that passenger compartments with roof modules consisting of the structural components in accordance with the invention have greater rigidity than conventional passenger compartments, which are exclusively produced from sheet metal.

It is clear that the aforesaid features and those still to be explained below can not only be used in the combination detailed in each case, but also in other combinations or however alone, without departing from the framework of the present invention.

### BRIEF DESCRIPTION OF THE DRAWINGS

The invention is illustrated schematically in the drawings on the basis of an embodiment and described in detail below with reference to the drawings, wherein:

FIG. 1 shows a simplified perspective view of a structural component in accordance with the invention; and

FIG. 2 shows a perspective view of half a mold tool in accordance with the invention for producing the structural component in FIG. 1.

### DETAILED DESCRIPTION OF THE PREFERRED EMBODIMENTS

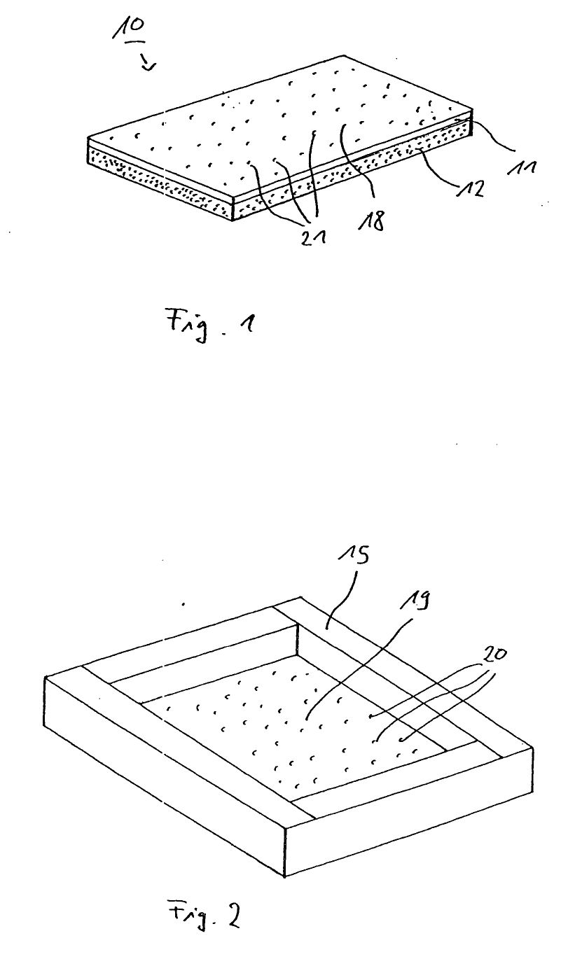

A structural component 10 in accordance with the invention is illustrated in FIG. 1 in a perspective view. The structural component 10 includes a varnish film 11, underside surface of which is back foamed with a carrier material 12, preferably with a PUR system. The carrier material 12 is well adhered to the varnish film 11 due to fusion of the varnish film 11 with the carrier material 12 on the boundary layer between these two materials and altogether imparts the wanted mechanical characteristics on the structural component 10.

Before the varnish film 11 is back foamed with the carrier material 12, it is thermoformed in a thermoforming die 15 (FIG. 2), in order to approximately acquire the definitive contour of the structural component to be produced. FIG. 2 shows a lower half of the thermoforming die 15. For carrying out thermoforming, the varnish film 11 is laid in the lower half of the thermoforming die 15. Subsequently, an upper half of the thermoforming die, which is not illustrated, is brought into contact with the lower half, whereby the two halves are constructed such that in the closed condition they form a cavity, which defines the wanted contour of the varnish film after thermoforming.

In FIG. 2 it is shown with “20” that a surface 19 of the lower half of the thermoforming die 15, the surface of which faces the die cavity, has a structure, which is suitably ingrained in the surface by means of etching, sand-blasting, coating or the like. If an exterior surface 18 of the varnish film 11 (FIG. 1) is pressed against the surface 19 during the thermoforming process, due to the temperature and pressure, which act upon the varnish film 11, the structure 20 of the surface 19 is replicated on the exterior surface 18 of the varnish film 11. The consequence being that the exterior surface 18 of the varnish film 11 has a surface structure 21 (see FIG. 1) after the thermoforming process has been carried out, which is evenly ingrained in the exterior surface. The surface structure 21 is formed by very small irregularities on the surface and causes uneven light reflection, whereby the optical appearance of the structural component 10 corresponds to the appearance of a conventional varnished metal part and optically is not to be distinguished therefrom.

FIG. 1 only shows a simplified illustration of the structural component 10 in the form of a flat plate. It is clear that by thermoforming, using a correspondingly contoured thermoforming die, a preferably curved shape is imparted on the varnish film 11, for example for producing an automobile mudguard. The structure 21 on the exterior surface 18 of the varnish film 11 is not affected by the back foaming process following thermoforming so that no further reworking of the structural component 10 is required after back foaming of the varnish film 11 with the carrier material 12.

The main aspect of the present invention includes in the fact that a sandwich structural component, having a varnish film and a carrier material, is provided with a surface structure on the exterior surface of the varnish film during the processing steps of contouring the varnish film and/or back molding and/or back filling the varnish film with the carrier material, which causes uneven light reflection. Such uneven reflection imparts the same optical appearance on the structural component in accordance with the invention as a conventional varnished metal part. Accordingly, the viewer cannot recognize so easily, or not at all, that the structural component in accordance with the invention is made of a plastic part. This leads to a substantial increase in the acceptance of such a plastic part.

Production of the wanted surface structure on the exterior surface of the varnish film during the processing steps mentioned above is ensured by the fact that a respective mold tool, that is to say a thermoforming and/or back injection molding die for example, has a surface facing the cavity, which is ingrained with the corresponding surface structure. If intensive contact of the varnish film with the die surface takes place due to pressure and temperature in particular during the processing steps of contouring, by way of thermoforming, and back molding, the structure of the die surface is replicated in negative form as required on the exterior surface of the varnish film. As already described above, the known methods of back foaming, back injection molding or also back pressing and back embossing, respectively, are suitable for back molding.

In particular if fiber-reinforced plastic is used for the carrier material, for example fiber-reinforced ABS or a fiber-reinforced blend of PBT and ASA, in addition high rigidity, minimum thermal linear expansion and good crash resistance can be achieved by the structural component in accordance with the invention. Alternatively to the plastics mentioned, other similar suitable types of plastic or blends of plastic can also be used.

The fiber material used for the materials mentioned consists for example of glass fibers, carbon fibers or the like, in each case as short or long fibers according to the required characteristic profile of the structural component in accordance with the invention.

The above-described embodiments of the invention are intended to be examples of the present invention and alterations and modifications may be effected thereto, by those skilled in the art, without departing from the scope of the invention which is defined solely by the claims appended hereto.

1. A method for manufacturing a structural component with a varnish exterior surface, the method including the steps of:
producing a varnish film, the exterior surface of which is substantially smooth,
contouring the varnish film, and
back molding the varnish film with a carrier material made from plastic, wherein during at least one of the two steps of contouring and back molding, an exterior surface of the varnish film is provided with a surface structure which causes uneven reflection of light on the exterior surface.

2. A method according to claim 1, wherein the varnish film produced is contoured by way of thermoforming.

3. A method according to claim 2, wherein the varnish film produced is an extruded film, which is varnished before thermoforming on its exterior surface.

4. A method according to claim 2, wherein the varnish film produced is a co-extruded film of a varnish coating and a carrier layer.

5. A method according to claim 1, wherein producing and contouring of the varnish film includes molding a Duromer molding material into a duroplast molding and subsequent varnishing the duroplast molding.

6. A method according to claim 1, wherein back molding is back foaming in particular with polyurethane.

7. A method according to claim 1, wherein back molding of the varnish film is back injection molding in particular with thermoplastics.

8. A method according to claim 1, wherein back molding of the varnish film is back embossing.

9. A method according to claim 8, wherein back embossing is carried out with a semi-finished product produced from one of a GMT material and a SMC material.

10. A structural component, having:
a varnish film, which has a varnish coating on its exterior surface, and
a carrier material, which is back molded on a side of the varnish film facing the exterior surface, wherein the exterior surface of the varnish film is provided with a surface structure, which causes uneven reflection of light on the exterior surface.

11. A structural component according to claim 10, wherein the varnish film is thermoformed.

12. A structural component according to claim 11, wherein the varnish film is formed from an extruded film, which has a varnish coating after being varnished.

13. A structural component according to claim 11, wherein the varnish film is formed from a co-extruded film, which has a varnish coating and a carrier layer.

14. A structural component according to claim 10, wherein the varnish film is made of a Duromer plastic molding material, wherein the varnish film is varnished after the Duromer plastic has cross-linked.

15. A structural component according to claim 10, wherein the carrier material includes a polyurethane system and the varnish film is back foamed with the carrier material.

16. A structural component according to claim 10, wherein the carrier material includes a thermoplastic sheet and the varnish film is back injection molded or back embossed with the carrier material.

17. A mold tool for carrying out contouring/back molding of a varnish film with a substantially smooth exterior surface, the mold tool comprising a surface facing the cavity of the die having a surface structure, which is replicated during contouring/back molding of the varnish film on its exterior surface, so that uneven reflection arises on the exterior surface.

18. A mold tool according to claim 17, wherein the surface facing the cavity is etched, sand-blasted and/or coated.
